(19) United States
(12) Patent Application Publication
(10) Pub. No.: US 2017/0090508 A1
(43) Pub. Date: Mar. 30, 2017

(54) METHOD AND APPARATUS FOR EFFECTIVE CLOCK SCALING AT EXPOSED CACHE STALLS

(71) Applicant: QUALCOMM Incorporated, San Diego, CA (US)

(72) Inventors: Shivam PRIYADARSHI, Raleigh, NC (US); Anil KRISHNA, Raleigh, NC (US); Raguram DAMODARAN, San Diego, CA (US); Jeffrey Todd BRIDGES, Raleigh, NC (US); Thomas Philip SPEIER, Wake Forest, NC (US); Rodney Wayne SMITH, Raleigh, NC (US); Keith Alan BOWMAN, Morrisville, NC (US); David Joseph Winston HANSQUINE, Raleigh, NC (US)

(21) Appl. No.: 14/865,092

(22) Filed: Sep. 25, 2015

(51) Int. Cl. G06F 1/08; G06F 12/12; G06F 12/08

(52) U.S. Cl. CPC G06F 1/08; G06F 12/0804; G06F 12/0875; G06F 12/0897; G06F 12/12; G06F 2212/1024; G06F 2212/60; G06F 2212/69

(57) ABSTRACT

The clock frequency of a processor is reduced in response to a dispatch stall due to a cache miss. In an embodiment, the processor clock frequency is reduced for a load instruction that causes a last level cache miss, provided that the load instruction is the oldest load instruction and the number of consecutive processor cycles in which there is a dispatch stall exceeds a threshold, and provided that the total number of processor cycles since the last level cache miss does not exceed some specified number.

### FIELD OF DISCLOSURE

Embodiments are directed to processors, and more particularly to processor microarchitectures that scale the processor clock frequency in response to a cache miss.

### BACKGROUND

The clock tree of a processor can consume a major component of the total power consumed by the processor. For example, for some modem processor designs it has been estimated that the clock tree dynamic power can be as high as 15% to 20% of the total processor core power. Assuming that the processor design is completely clock gated, for such an example the processor will always dissipate a non-appreciable amount of power while running regardless of whether the processor is active or idle when waiting for data from a memory sub-system.

### SUMMARY

Exemplary embodiments of the invention are directed to systems and method for for effective clock scaling at exposed cache stalls.

[I typically complete this section in the final draft after the claims have been approved.]

### BRIEF DESCRIPTION OF THE DRAWINGS

The accompanying drawings are presented to aid in the description of embodiments of the invention and are provided solely for illustration of the embodiments and not limitation thereof.

FIG. 1 is a high-level microarchitecture of a processor according to an embodiment.

FIG. 2 is a state diagram for a state machine according to an embodiment.

FIGS. 3A, 3B, and 3C illustrate flow diagrams for detecting a candidate load instruction according to an embodiment.

FIG. 4 is illustrates an electronic device in which an embodiment may find application.

### DETAILED DESCRIPTION

Embodiments of the invention are disclosed in the following description and related drawings. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A processor according to an embodiment identifies when it is most likely stalled while waiting for data from system memory, and as a result scales down its clock frequency while waiting for the data to return from a memory sub-system (e.g., off-chip system memory). The processor returns to full clock frequency when the cache stall condition is lifted. This mechanism is aimed at reducing the power consumed in a clock tree without appreciably affecting performance.

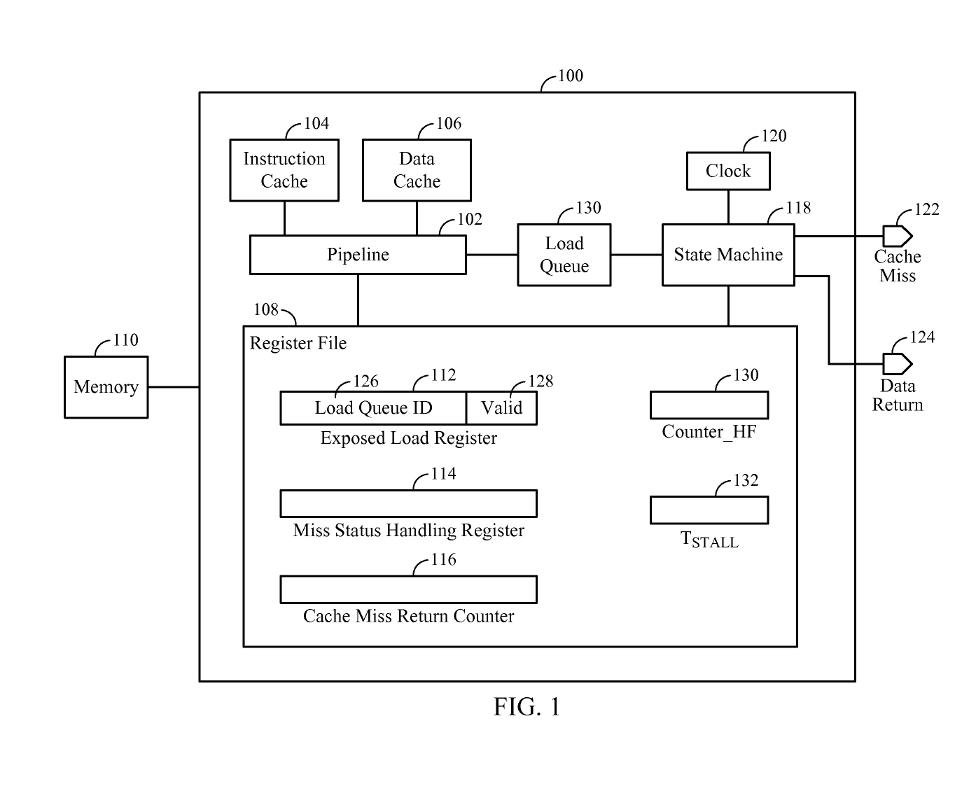

FIG. 1 illustrates the microarchitecture of the processor 100 according to an embodiment. For ease of illustration, not all components of a typical processor microarchitecture are shown. The pipeline 102 fetches instructions, such as load instructions or store instructions, from the instruction cache 104, has access to the data cache 106 to execute various instructions, and has access to the registers in the register file 108.

The memory 110 represents off-chip memory that may include system memory, caches at a higher level than the instruction cache 104 or the data cache 106, or any combinations thereof. For example, the memory 110 may represent a memory hierarchy that includes L2 (level 2) cache, and other system memory components that may include both volatile and non-volatile memory.

Embodiments make use of one or more of the three registers shown in the register file 108: the register 112, referred to as the exposed load register 112; the register 114, referred to as the miss status handling register 114 (MSHR 114); and the register 116, referred to as the cache miss return counter 116. In practice, there may be more than one MSHR. Accordingly, the term “MSHRs 114” may be used to indicate a plurality of miss status handling registers. The state machine 118 has access to the registers 112, 114, and 116, and receives the cache miss signal at the input port 122 and the data return signal at the input port 124. As will be described in more detail below, the state machine 118 sets the clock 120 to a low frequency or a high-frequency depending upon the state stored in the state machine 118, the values stored in one or more of the registers 112, 114, and 116, and the cache miss signal and the data return signal.

Because the processor 100 may be viewed as a state machine, the states of the state machine 118 as described below may also be viewed as possible states of the processor 100.

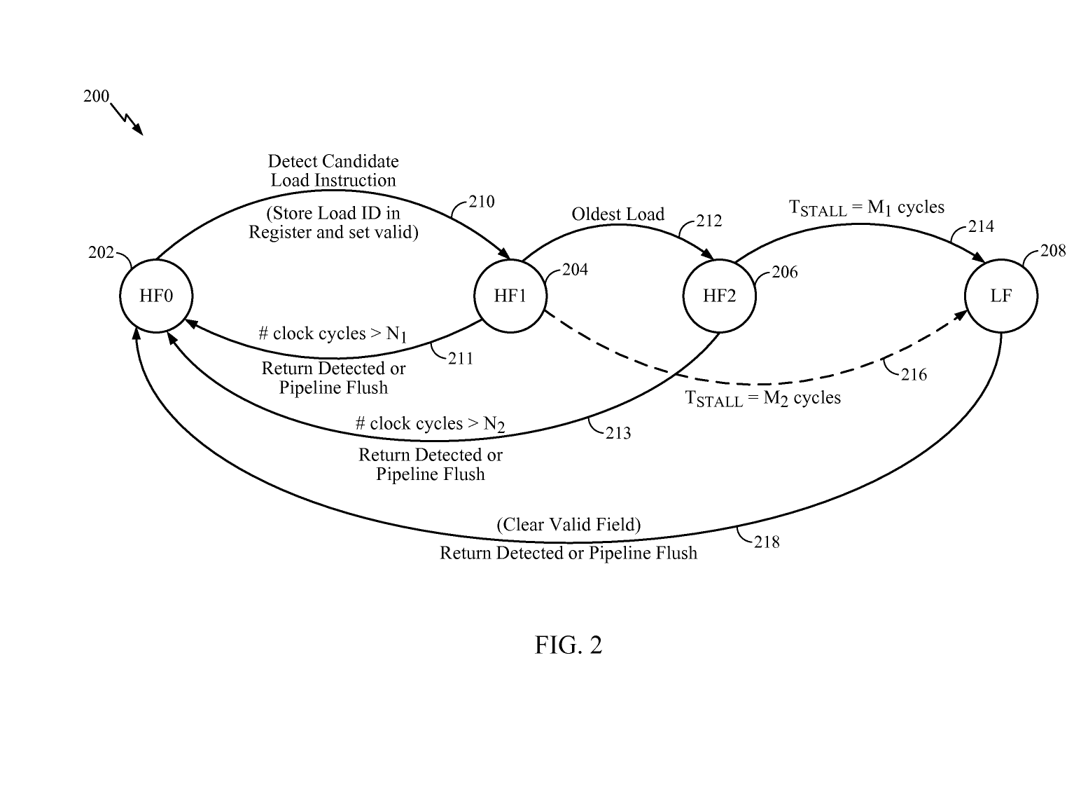

FIG. 2 illustrates the state transition diagram 200 for the state machine 118 according to an embodiment. Illustrated in FIG. 2 are four states: the state 202, the state 204, the state 206, and the state 208. The states 202, 204, and 206 may also be referred to, respectively, as the HF0 state, the HF1 state, and the HF2 state, and are represented as such in FIG. 2. The “HF” in these state designations is a mnemonic for “high frequency,” where as described further, the processor 100 is operated (or gated) at the normal operating frequency, i.e., a relatively high frequency, when the state machine 118 is in any one of the states HF0, HF1, and HF2. The state 208 may also be referred to as the LF state, and is represented as such in FIG. 2. The “LF” is a mnemonic for “low frequency,” where as described further, the processor 100 is operated (or gated) at a frequency less than the normal operating frequency, i.e., a relatively low frequency, when the state machine 118 is in the LF state.

The clock 120 in FIG. 1 may represent a generator for providing a clock signal, or a circuit for gating the processor 100 so as to operate at one or more clock frequencies. Accordingly, when describing the embodiments, reference to setting the clock 120 to some frequency is to be understood to also include the action of gating the processor 100 so that its operating frequency may be adjusted.

When the state machine 118 is in one of the states 202, 204, or 206, the clock 120 is operated at the high frequency, whereas when the state machine 118 is in the state 208 the clock 120 is operated at the low frequency. Initially, the state machine 100 is in the HF0 state, so that this state may also be referred to as the initial state. The state transition 210 from the state 202 (the HF0 or initial state) to the state 204 (the HF1 state) occurs when a candidate load instruction is detected.

A candidate load instruction is a load instruction that causes a last level cache miss, such that the load instruction is not in the shadow of an earlier executed load instruction that is causing a dispatch stall due to a last level cache miss. (A dispatch stall is sometimes referred to as a cache stall.) That is, a candidate load instruction is a load instruction that causes a last level cache miss when there are no other outstanding load instructions in the pipeline 102 that caused a last level cache miss. The “last level” cache refers to that cache having the highest level in the memory hierarchy represented by the memory 110. For example, the last level cache in the memory 110 may be an L2 (Level 2) cache. In some embodiments, the last level cache may be integrated in the processor 100. Different embodiments for detecting a candidate load instruction are described later.

In response to detecting a candidate load instruction, the pipeline 102 stores the load instruction ID (identification) in the field 126 of the exposed load register 112, and sets the field 128 of the exposed load register 112 to indicate that the content of the exposed load register 112 is valid. The field 128 may be referred to as a valid field, or valid bit. This response to detecting a candidate load instruction is indicated within the parentheses next to the state transition 210.

The state transition 212 from the HF1 state to the HF2 state occurs in response to the processor 100 determining that the candidate load instruction is the oldest load instruction that has not yet retired. The oldest load instruction may be determined by accessing the load queue 130. However, note the state transition 211 from the HF1 state to the HF0 state. The state transition 211 occurs when the number of clock cycles since the state machine 118 entered the HF1 state exceeds a threshold, denoted as N₁ in FIG. 2. Additionally, the state transition 211 occurs if the data return signal at the input port 124 indicates that data (requested by the candidate load instruction) has been retrieved from the memory 110, or if the pipeline 102 is flushed. Accordingly, the state transition 212 does not occur if N₁ processor clock cycles have elapsed since the state machine 118 transitioned from the HF0 state to the HF1 state. In other words, the condition that N₁ processor clock cycles have not elapsed since the state machine 118 transitioned from the HF0 state to the HF1 state is a necessary condition for the state transition 212.

The register 130, referred to as the counter_HF register in FIG. 1, can be used to keep track of the number of clock cycles since the state machine 118 transitioned from the HF0 state to the HF1 state (that is, when the state machine 118 detects a candidate load instruction). The counter_HF register is initialized sometime before or when the state machine 118 enters the HF1 state, and is incremented thereafter on each processor clock cycle.

The state transition 214 from the HF2 state to the LF state occurs in response to the processor 100 detecting that a dispatch stall variable T_{STALL} has reached M₁ consecutive clock cycles. In one embodiment, the dispatch stall variable T_{STALL} begins counting from the time the candidate load instruction becomes the oldest load instruction, where the dispatch stall variable T_{STALL} is in units of processor clock cycles. That is, the dispatch stall variable T_{STALL} is initialized when or sometime before the state machine 118 entered the HF2 state, and is incremented thereafter for each processor clock cycle, whereupon the LF state is entered if the stall variable T_{STALL} reaches M₁. The value of T_{STALL} may be stored in the register 132, where for example the state machine 118 resets the value of the register 132 to zero at the beginning of each dispatch stall.

When entering the LF state, the state machine 118 sets the clock 120 (or gates the processor 100) to the low frequency so as to achieve power savings without an appreciable loss in performance. However, note the state transition 213 from the HF2 state to the HF0 state, which occurs when the number of clock cycles since the state machine 118 entered the HF2 state exceeds a threshold, denoted as N₂ in FIG. 2. The integer N₁ need not equal the integer N₂. Additionally, the state transition 213 occurs if the data return signal at the input port 124 indicates that data (requested by the candidate load instruction) has been retrieved from the memory 110, or if the pipeline 102 is flushed.

Accordingly, the state transition 214 occurs only if N₂ processor clock cycles have not elapsed since the state machine 118 transitioned from the HF1 state to the HF2 state. As before, the register 130 may be used for counting the number of clock cycles since the state machine 118 transitioned from the HF1 state to the HF2 state.

The state transition 218 from the LF state to the HF0 state occurs in response to a memory return in which data from the memory 110 is returned from the target memory location of the load instruction, or when there is a pipeline flush. In response to the state transition 218, the field 128 is cleared to indicate that the content of the exposed load register 112 is no longer valid.

In another embodiment, the HF2 state may be skipped as indicated by the dashed line for the state transition 216. In such an embodiment, the candidate load instruction need not be determined to be the oldest load instruction as indicated by the state transition 212. Rather, the state machine 118 transitions from the HF1 state directly to the LF state in response to detecting that the dispatch stall variable T_{STALL} has reached M₂ consecutive clock cycles, where in this case the dispatch stall variable T_{STALL} begins counting when the last level cache miss occurred, that is, when the state machine 118 entered the HF1 state. The integer M₁ need not equal the integer M₂. But again, a necessary condition for the state transition 216 is that the number of processor clock cycles since the state machine 118 transitioned from the HF0 state to the HF1 state does not exceed N₁.

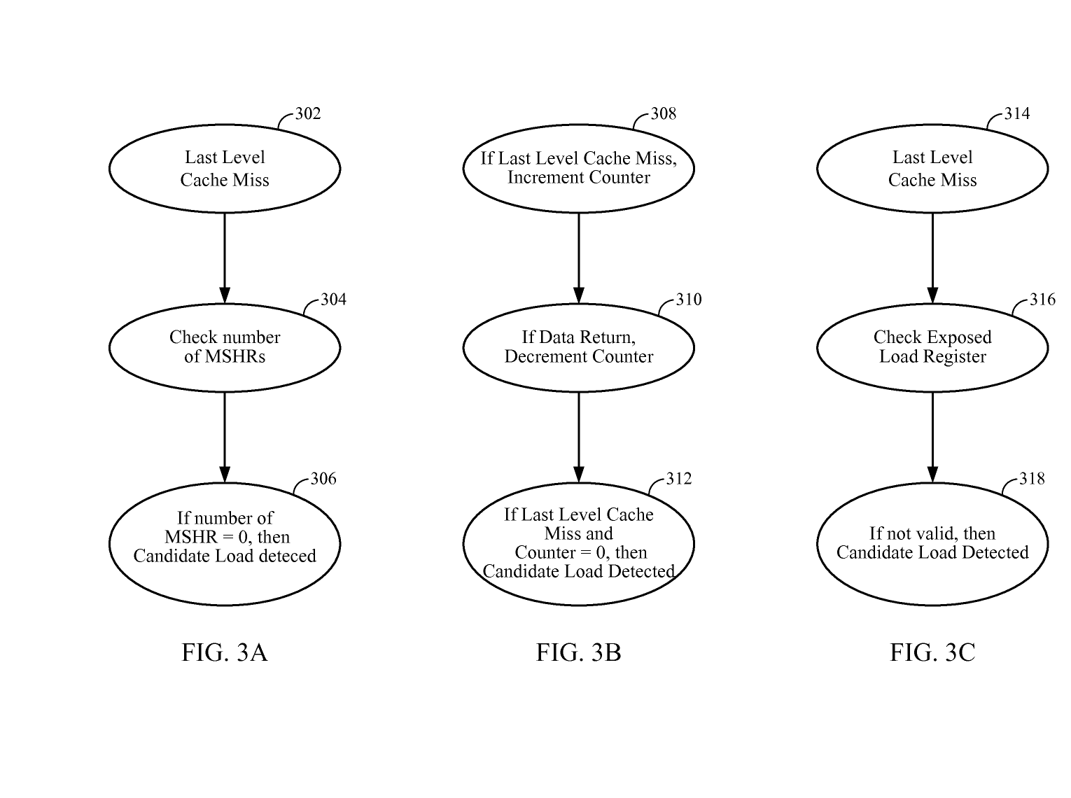

FIGS. 3A, 3B, and 3C illustrate three embodiments for detecting a candidate load instruction. Referring to the embodiment illustrated in FIG. 3A, if a load instruction causes a last level cache miss (302), then the number of MSHRs 114 with valid content is determined (304). If the number of such registers is zero, then the load instruction is declared to be a candidate load instruction (306). When a software process begins, the MSHRs 114 can be initialized so that all of their content is invalid.

In the embodiment illustrated in FIG. 3B, the cache miss return counter 116 is incremented when a load instruction causes a last level cache miss (308), and the cache miss return counter 116 is decremented when the data from the target memory location for a load instruction causing the last level cache miss is returned (310), i.e., there is a memory return. As indicated in the action 312, whenever there is a last level cache miss and it is determined that the cache miss return counter 116 is zero, then the load instruction causing that last level cache miss is declared to be a candidate load instruction. This assumes that zero is the initial value of the cache miss return counter 116.

In the embodiment illustrated in FIG. 3C, when a load instruction causes a last level cache miss as indicated in the action 314, then the processor 100 checks the exposed load register 112 in the action 316. If the content of the exposed load register 112 is not valid, then as indicated in the action 318, the load instruction causing the last level cache miss is declared to be a candidate load instruction.

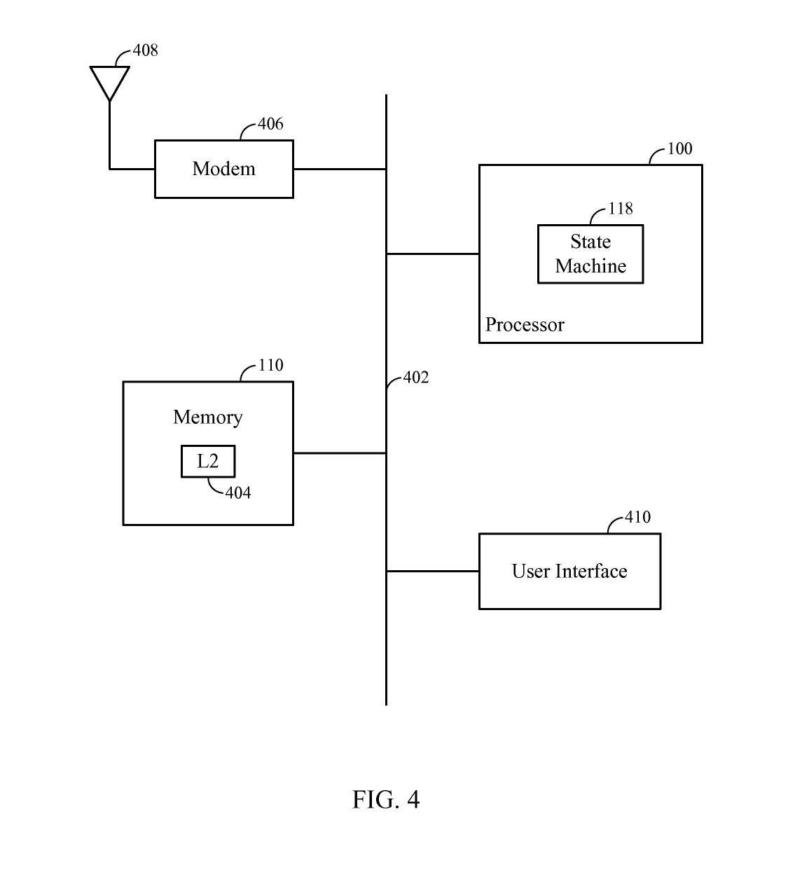

Embodiments may find application in a number of devices, such as for example a cellular phone, laptop, or computer server, or a power efficient appliance with Internet connectivity, to name just a few examples. FIG. 4 illustrates an example of an electronic device in which an embodiment may find application, where the processor 100 with the state machine 118 is coupled to the memory 110 by way of the bus 402. In the particular example of FIG. 4, the last level cache is the L2 cache 404. Also shown in FIG. 4 is the modem 406 coupled to the antenna 408 so that wireless connectivity to a router, access point, or cellular phone tower may be realized. The user interface 410 represents one or more devices by which a user may interact with the electronic device, such as for example a touch sensitive screen or keyboard.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, or a combination of computer software and hardware. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be implemented as electronic hardware, or a combination of computer software and hardware, executed by a processor (it being understood that “processor” may include multiple processors or multiple processor cores) and electronic circuits. A software module for implementing part of an embodiment may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an embodiment of the invention can include a computer readable media embodying a method for effective clock scaling at exposed cache stalls. Accordingly, the invention is not limited to illustrated examples and any means for performing the functionality described herein are included in embodiments of the invention.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A processor comprising:
a register file having a register;
a pipeline, wherein upon detecting a load instruction causing a last level cache miss while there are no other outstanding load instructions in the pipeline that caused another last level cache miss, the pipeline stores in the register an identification of the load instruction and sets a field in the register to indicate the content of the register is valid; and
a state machine coupled to the register file and the pipeline, wherein the state machine transitions from an initial state to a first state in response to the pipeline storing the identification in the register, the state machine transitions from the first state to a second state in response to the load instruction being the oldest load instruction in the pipeline, and the state machine transitions from the second state to a low frequency state in response to the processor operating over M contiguous processor clock cycles since the state machine transitioned to the second state, where M is an integer;
wherein the processor operates at a first clock frequency when the state machine is in the initial, first, or second states, and operates at a second clock frequency when the state machine is in the low frequency state, where the first clock frequency is higher than the second clock frequency.

2. The processor of claim 1, wherein the state machine transitions from the low frequency state to the initial state in response to a memory return for the load instruction, or a pipeline flush.

3. The processor of claim 1, wherein the state machine transitions from the first state to the initial state in response to a memory return for the load instruction, a pipeline flush, or the processor operating over N₁ processor clock cycles since the state machine transitioned from the initial state to the first state, where N₁ is an integer.

4. The processor of claim 1, wherein the state machine transitions from the second state to the initial state in response to a memory return for the load instruction, a pipeline flush, or the processor operating over N₂ processor clock cycles since the state machine transitioned to the second state, where N₂ is an integer.

5. The processor of claim 4, wherein the state machine transitions from the first state to the initial state in response to a memory return for the load instruction, a pipeline flush, or the processor operating over N₁ processor clock cycles since the state machine transitioned from the initial state to the first state, where N₁ is an integer.

6. The processor of claim 1, wherein the pipeline sets the field to indicate the content of the register is not valid when the state machine returns to the initial state.

7. The processor of claim 6, wherein the pipeline stores in the register the identification of the load instruction provided before storing the identification the field indicates the content of the register is not valid.

8. The processor of claim 1, the register file comprising at least one miss status handling register,
wherein the pipeline stores in the register the identification of the load instruction provided the at least one miss status handling register has invalid content.

9. The processor of claim 1, the register file comprising a cache miss return counter having an initial value,
wherein the pipeline increments the cache miss return counter for each cache miss and decrements the cache miss return counter for each memory return;
wherein the pipeline stores in the register the identification of the load instruction provided the cache miss return counter has the initial value.

10. A processor comprising:
a register file having a register;
a pipeline, wherein upon detecting a load instruction causing a last level cache miss while there are no other outstanding load instructions in the pipeline that caused another last level cache miss, the pipeline stores in the register an identification of the load instruction and sets a field in the register to indicate the content of the register is valid; and
a state machine coupled to the register file and the pipeline, wherein the state machine transitions from an initial state to a first state in response to the pipeline storing the identification in the register, and the state machine transitions from the first state to a low frequency state in response to the processor operating over M contiguous processor clock cycles since the state machine transitioned to the first state, where M is an integer;
wherein the processor operates at a first clock frequency when the state machine is in the initial state or the first state, and operates at a second clock frequency when the state machine is in the low frequency state, where the first clock frequency is higher than the second clock frequency.

11. The processor of claim 10, wherein the state machine transitions from the low frequency state to the initial state in response to a memory return for the load instruction, or a pipeline flush.

12. The processor of claim 10, wherein the state machine transitions from the first state to the initial state in response to a memory return for the load instruction, a pipeline flush, or the processor operating over N processor clock cycles since the state machine transitioned from the initial state to the first state, where N is an integer.

13. The processor of claim 10, wherein the pipeline sets the field to indicate the content of the register is not valid when the state machine returns to the initial state.

14. The processor of claim 13, wherein the pipeline stores in the register the identification of the load instruction provided before storing the identification the field indicates the content of the register is not valid.

15. The processor of claim 10, the register file comprising at least one miss status handling register,
wherein the pipeline stores in the register the identification of the load instruction provided the at least one miss status handling register has invalid content.

16. The processor of claim 10, the register file comprising a cache miss return counter having an initial value,
wherein the pipeline increments the cache miss return counter for each cache miss and decrements the cache miss return counter for each memory return;
wherein the pipeline stores in the register the identification of the load instruction provided the cache miss return counter has the initial value.

17. A method to scale a processor clock frequency in a processor during dispatch stalls, the processor comprising a pipeline to execute instructions, the method comprising:
storing in a register of the processor an identification of a load instruction causing a last level cache miss while there are no other outstanding load instructions in the pipeline that caused another last level cache miss, and setting a field in the register to indicate the content of the register is valid;
transitioning the processor from an initial state to a first state in response to the pipeline storing the identification in the register;
transitioning the processor from the first state to a second state in response to the load instruction being the oldest load instruction in the pipeline;
transitioning the processor from the second state to a low frequency state in response to the processor operating over M contiguous processor clock cycles since the processor transitioned to the second state, where M is an integer;
operating the processor at a first clock frequency when in the initial, first, or second states; and
operating the processor at a second clock frequency when in the low frequency state, where the first clock frequency is higher than the second clock frequency.

18. The method of claim 17, further comprising:
transitioning the processor from the low frequency state to the initial state in response to a memory return for the load instruction, or a pipeline flush;
transitioning the processor from the first state to the initial state in response to a memory return for the load instruction, a pipeline flush, or the processor operating over N₁ processor clock cycles since transitioning from the initial state to the first state, where N₁ is an integer;
transitioning the processor from the second state to the initial state in response to a memory return for the load instruction, a pipeline flush, or the processor operating over N₂ processor clock cycles since transitioning from the first state to the second state, where N₂ is an integer; and
setting the field to indicate the content of the register is not valid when returning to the initial state.

19. The method of claim 18, wherein storing in the register the identification of the load instruction occurs provided before storing the identification the field indicates the content of the register is not valid.

20. The method of claim 17, the processor comprising at least one miss status handling register, wherein storing in the register of the processor the identification of the load instruction occurs provided none of the at least one miss status handling register has valid content.

21. The method of claim 17, the register file comprising a cache miss return counter having an initial value, the method further comprising:
incrementing the cache miss return counter for each cache miss; and
decrementing the cache miss return counter for each memory return;
wherein storing in the register of the processor the identification of the load instruction occurs provided the cache miss return counter has the initial value.

22. A method to scale a processor clock frequency in a processor during dispatch stalls, the processor comprising a pipeline to execute instructions, the method comprising:
storing in a register of the processor an identification of a load instruction causing a last level cache miss while there are no other outstanding load instructions in the pipeline that caused another last level cache miss, and setting a field in the register to indicate the content of the register is valid;
transitioning the processor from an initial state to a first state in response to the pipeline storing the identification in the register;
transitioning the processor from the first state to a low frequency state in response to the processor operating over M contiguous processor clock cycles since entering the first state, where M is an integer;
operating the processor at a first clock frequency when in the initial state or the first state; and
operating the processor at a second clock frequency when in the low frequency state, where the first clock frequency is higher than the second clock frequency.

23. The method of claim 22, further comprising:
transitioning the processor from the low frequency state to the initial state in response to a memory return for the load instruction, or a pipeline flush;
transitioning the processor from the first state to the initial state in response to a memory return for the load instruction, a pipeline flush, or the processor operating over N processor clock cycles since transitioning from the initial state to the first state, where N is an integer; and
setting the field to indicate the content of the register is not valid when returning to the initial state.

24. The method of claim 23, wherein storing in the register the identification of the load instruction occurs provided before storing the identification the field indicates the content of the register is not valid.

25. The method of claim 22, the processor comprising at least one miss status handling register, wherein storing in the register of the processor the identification of the load instruction occurs provided the at least one miss status handling register has invalid content.

26. The method of claim 22, the register file comprising a cache miss return counter having an initial value, the method further comprising:
incrementing the cache miss return counter for each cache miss; and
decrementing the cache miss return counter for each memory return;
wherein storing in the register of the processor the identification of the load instruction occurs provided the cache miss return counter has the initial value.

27. A processor comprising:
a register;
a pipeline to execute instructions;
means for storing in the register of the processor an identification of a load instruction causing a last level cache miss while there are no other outstanding load instructions in the pipeline that caused another last level cache miss, and setting a field in the register to indicate the content of the register is valid;
means for transitioning from an initial state to a first state in response to the pipeline storing the identification in the register;
means for transitioning from the first state to a second state in response to the load instruction being the oldest load instruction in the pipeline;
means for transitioning from the second state to a low frequency state in response to the processor operating over M contiguous processor clock cycles since the processor entered the second state, where M is an integer;
means for operating the processor at a first clock frequency when in the initial, first, or second states; and
means for operating the processor at a second clock frequency when in the low frequency state, where the first clock frequency is higher than the second clock frequency.

28. A processor comprising:
a register;
a pipeline to execute instructions;
means for storing in the register of the processor an identification of a load instruction causing a last level cache miss while there are no other outstanding load instructions in the pipeline that caused another last level cache miss, and setting a field in the register to indicate the content of the register is valid;
means for transitioning from an initial state to a first state in response to the pipeline storing the identification in the register;
means for transitioning from the first state to a low frequency state in response to the processor operating over M contiguous processor clock cycles since the processor entered the first state, where M is an integer;
means for operating the processor at a first clock frequency when in the initial state or the first state; and
means for operating the processor at a second clock frequency when in the low frequency state, where the first clock frequency is higher than the second clock frequency.
